(19) United States
(12) Patent Application Publication
(10) Pub. No.: US 2024/0262182 A1
(43) Pub. Date: Aug. 8, 2024

(54) FUEL TANK

(71) Applicant: YACHIYO INDUSTRY CO., LTD., Saitama (JP)

(72) Inventors: Kazunari NAKAYA, Tochigi (JP); Masaki MORISAKI, Tochigi (JP); Kazuyoshi MOROOKA, Tochigi (JP)

(21) Appl. No.: 18/290,929

(22) PCT Filed: Jul. 14, 2022
(86) PCT No.: PCT/JP2022/027650

§ 371 Date: Jan. 22, 2024

(30) Foreign Application Priority Data
Jul. 26, 2021 (JP) 2021-121243

(51) Int. Cl. B60K 15/03

(52) U.S. Cl. CPC B60K 15/03; B60K 2015/03328

(57) ABSTRACT

A fuel tank includes: an internal component including a head portion, a neck portion, and a shoulder portion. The internal component is fixed on the tank main body by shaping a parison to the head portion, the neck portion and the shoulder portion during molding of the tank main body. At least one of the head portion and the neck portion includes a bottom portion (a fuse-shaped portion) configured to be broken near a boundary between the head portion and the neck portion.

### CROSS-REFERENCE TO RELATED APPLICATION

This application is a U.S. National Stage Application under 35 U.S.C § 371 of International Patent Application No. PCT/JP2022/027650 filed on Jul. 14, 2022, which claims the benefit of priority to Japanese Patent Application No. 2021-121243 filed on Jul. 26, 2021, the disclosures of all of which are hereby incorporated by reference in their entireties.

### TECHNICAL FIELD

The present invention relates to a fuel tank.

### BACKGROUND ART

A recognized method exists for affixing components, such as valves, to blow-molded products, notably automobile fuel tanks, as internal components. For example, Patent Literature 1 describes a method for manufacturing a fuel tank that integrates an internal component, which includes a head portion, neck portion, and shoulder portion. Within this method of fuel tank fabrication, the parison is shaped along the neck portion by sending in air from the exterior of the parison during the tank main body molding process, thus anchoring the internal component to the tank main body.

### CITATION LIST

### Patent Document

Patent Document 1: International Publication No. WO2018/225413

### SUMMARY OF INVENTION

### Technical Problem

When the pressure inside the fuel tank increases, causing the tank main body to deform under positive pressure, there is a risk that the wall portion of the tank main body near the neck portion could be broken.

Therefore, an object of the present invention is to provide a fuel tank that can prevent breakage of the wall portion of the tank main body.

### Solution to Problem

To achieve the aforementioned object, the present invention is a fuel tank which includes an internal component including a head portion, a neck portion, and a shoulder portion, the internal component being fixed on a tank main body by shaping a parison to the head portion, neck portion, and shoulder portion during molding of the tank main body. At least one of the head portion and the neck portion includes a fuse-shaped portion to be broken near a boundary between the head portion and neck portion. The head portion is formed with multiple cutout portions opening to an end surface of the head portion, and fuse-shaped portions are formed on radially outer side of the head portion and continuously with the multiple cutout portions.

The present invention is fuel tank which includes an internal component including a head portion, a neck portion, and a shoulder portion, the internal component being fixed on the tank main body by shaping a parison to the head portion, the neck portion and the shoulder portion during molding of the tank main body. At least one of the head portion and the neck portion includes a fuse-shaped portion to be broken near a boundary between the head portion and the neck portion. Multiple cutout portions are formed to communicate from the head portion to the neck portion and open to an end surface of the head portion. Fuse-shaped portions are formed on radially outer side of the neck portion and continuously with the multiple cutout portions.

According to the present invention, by having the fuse-shaped portion, when a predetermined positive pressure is applied, the internal component can be broken near the boundary between the head portion and neck portion. As a result, the broken portion remains on the wall portion of the tank main body, and the other portions can be detached from the wall portion of the tank main body, thereby preventing damage to the wall portion of the tank main body. According to the present invention, use of the cutout portions allows for easy formation of the fuse-shaped portions.

The present invention is a fuel tank which includes an internal component including a head portion, a neck portion, and a shoulder portion, the internal component being fixed on the tank main body by shaping a parison to the head portion, the neck portion and the shoulder portion during molding of the tank main body. At least one of the head portion and the neck portion includes a fuse-shaped portion to be broken near a boundary between the head portion and the neck portion. The head portion includes a bottom portion to be the fuse-shaped portion, and a side wall standing from the bottom portion. The bottom portion has a constant thickness in a circumference direction.

The present invention is a fuel tank which includes an internal component including a head portion, a neck portion, and a shoulder portion, the internal component being fixed on the tank main body by shaping a parison to the head portion, the neck portion and the shoulder portion during molding of the tank main body. At least one of the head portion and the neck portion includes a fuse-shaped portion to be broken near a boundary between the head portion and the neck portion. The neck portion includes a side wall to be the fuse-shaped portion. The side wall has a constant thickness in a circumference direction.

According to the present invention, by having the fuse-shaped portion, when a predetermined positive pressure is applied, the internal component can be broken near the boundary between the head portion and neck portion. As a result, the broken portion remains on the wall portion of the tank main body, and the other portions can be detached from the wall portion of the tank main body, thereby preventing damage to the wall portion of the tank main body.

### Advantageous Effects of Invention

The present invention makes it possible to prevent breakage of the wall portion of the tank main body.

### BRIEF DESCRIPTION OF DRAWINGS

FIG. 1 is a schematic cross-sectional view of a fuel tank according to an embodiment of the present invention.

FIG. 2 is an external perspective view of an internal component.

FIG. 3 is a front view of the internal component.

FIG. 4 is a plan view of the internal component.

FIG. 5 is an enlarged sectional view of the internal component.

FIG. 6A is an enlarged sectional view of an end surface of a construction in which the internal component is fixed on the fuel tank.

FIG. 6B is an enlarged sectional view of another end surface of the construction in which the internal component is fixed on the fuel tank.

FIG. 7 is a schematic longitudinal cross-sectional view of a fuel tank manufacturing device.

FIG. 8 is a diagram for explaining the transfer status of the parison around the end portion of the internal component during molding.

FIG. 9 is a diagram for explaining the transfer status of the parison around the end portion of the internal component during molding.

FIGS. 10A to 10C are each a diagram for explaining the method for manufacturing a fuel tank in the fuel tank manufacturing device, where FIG. 10A shows the injection process of the parison, FIG. 10B shows the insertion process of the internal component, and FIG. 10C shows the temporary setting process of the internal component.

FIGS. 11A to 11D are each a diagram for explaining the method for manufacturing a fuel tank in the fuel tank manufacturing device, where FIG. 11A shows the closing process of the mold, FIG. 11B shows the blow molding process, FIG. 11C shows the cooling process of the parison, and FIG. 11D shows the opening process of the mold.

FIG. 12 is a sectional view which shows an action of a conventional fuel tank.

FIG. 13 is a sectional view which shows an action of a fuel tank according to the embodiment.

FIG. 14 is a sectional view which shows an action of the fuel tank according to a modification.

### DESCRIPTION OF EMBODIMENTS

### <<Fuel Tank According to Embodiment>>

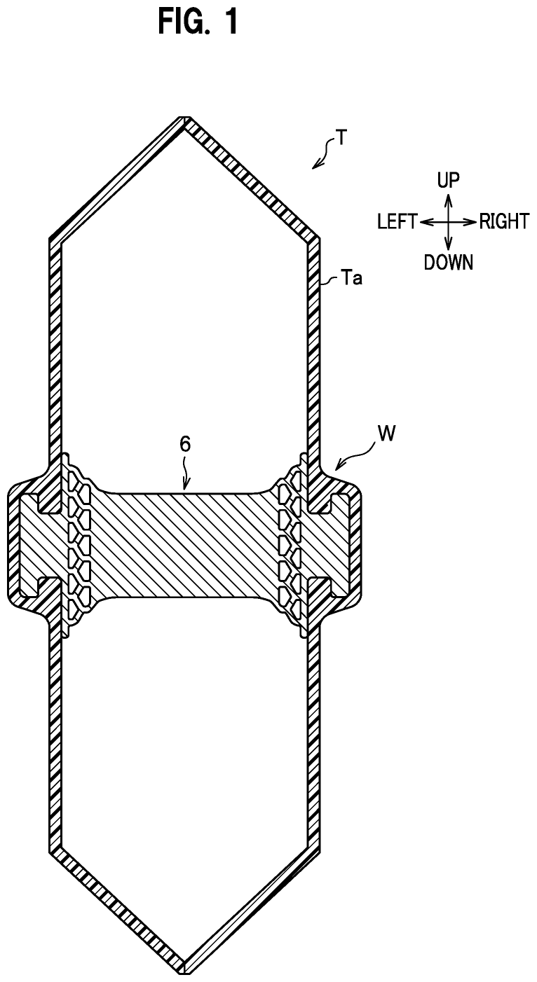

The fuel tank T shown in FIG. 1 is intended for installation in vehicles such as automobiles, motorcycles, and boats, and mainly includes a tank main body Ta and an internal component 6. As shown in FIG. 1, the present embodiment exemplifies a columnar reinforcement member as the internal component 6 to maintain the strength of the fuel tank T, but the internal component 6 can also be a valve or a wave damping plate. The terms “up and down” and “left and right” in the following description refer to the arrows in FIG. 1. Each direction is defined for the convenience of the description and does not limit the present invention. The left and right directions in FIG. 1 correspond to the opening and closing directions of a pair of molds used to manufacture the fuel tank T.

The tank main body Ta is a hollow container made of resin for storing fuels such as gasoline, and has a multilayered structure that includes a barrier layer, for example. The tank main body Ta is primarily made of thermoplastic resin such as polyethylene or high-density polyethylene. The tank main body Ta is formed, for instance, by blow molding.

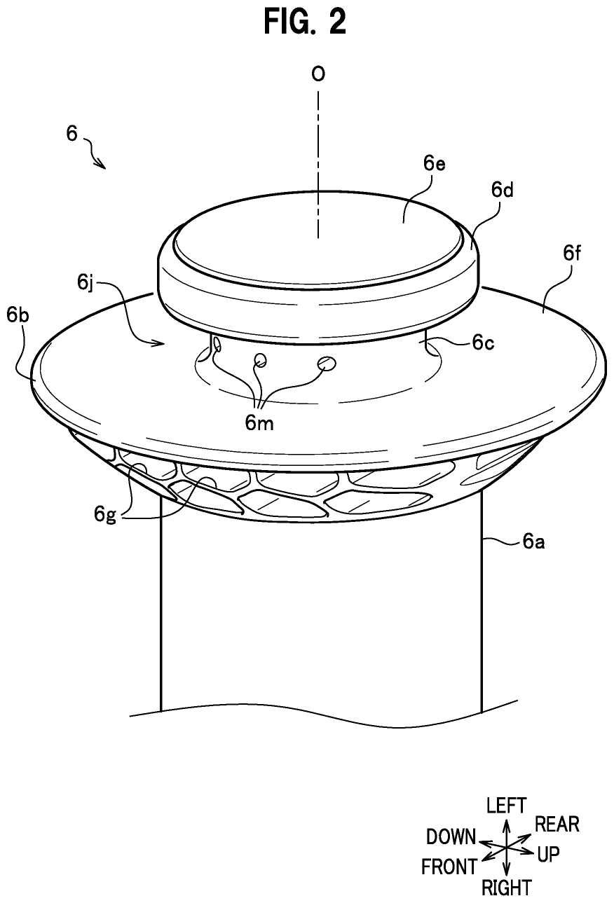

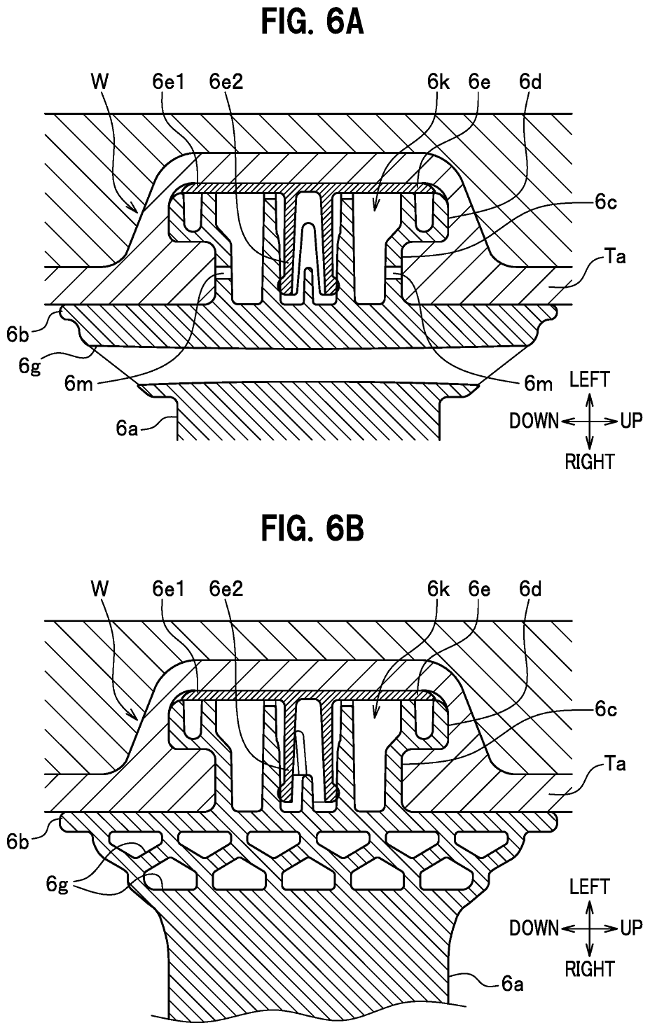

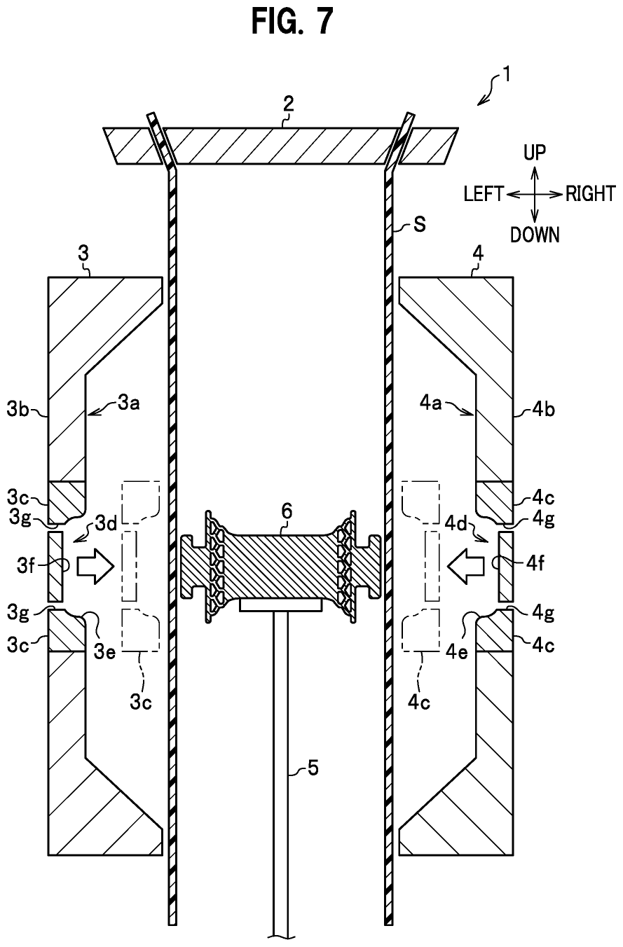

In reference to FIGS. 2 through 6A and 6B, the composition of the internal component 6 will be described. The internal component 6 may be made of either a material that can be welded to the precursor of the tank main body Ta, a parison S (see FIG. 7) (for example, thermoplastic resins such as PE (polyethylene)) or a material that cannot be welded (such as POM (polyacetal)). The parison S has a structure made of multilayered HDPE (high-density polyethylene), EVOH (ethylene-vinyl alcohol copolymer), adhesive layers, and the like.

As shown in FIG. 2, the internal component 6 includes a torso portion 6a, shoulder portions 6b, 6b formed at both ends of the torso portion 6a, neck portions 6c, 6c formed outside of the shoulder portions 6b, 6b, and head portions 6d, 6d. The structure of the internal component 6 is symmetrical in left and right (up and down on the paper). Therefore, unless explicitly stated, only one side will be described here. In the description of the internal component 6, the surface facing the torso portion 6a is referred to as the “back surface,” and the surface opposite to the “back surface” is referred to as the “front surface.”

The torso portion 6a shown in FIG. 2 is a portion corresponding to the main body of the internal component 6. The torso portion 6a has a cylindrical shape, and the distal end thereof radially expands as it approaches the shoulder portion 6b. Multiple hollowing holes 6g are formed at the end portion of the torso portion 6a. The hollowing holes 6g are places where air circulates while the later-described parison S is shaped into the internal component 6.

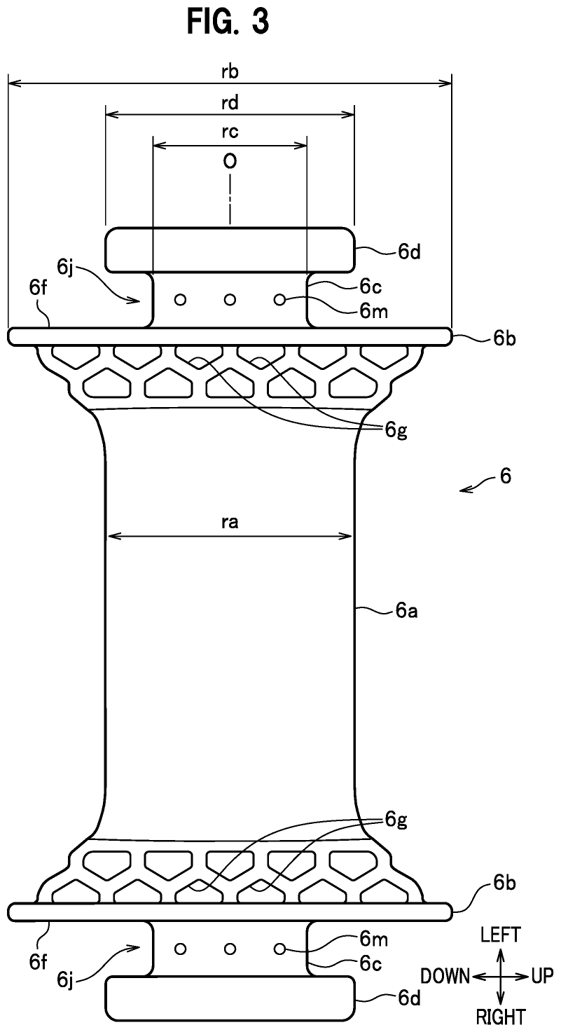

The shoulder portion 6b shown in FIG. 2 covers the recess 3d of the first mold 3 or the recess 4d of the second mold 4, shown in FIG. 7. The shape and size of the shoulder portion 6b are not particularly limited, as long as they can cover the recesses 3d, 4d. Here, the shoulder portion 6b has a thin circular plate shape, and as shown in FIG. 3, the outer diameter rb of the shoulder portion 6b is larger than the outer diameter ra of the torso portion 6a.

The neck portion 6c shown in FIG. 2 is a portion connecting the shoulder portion 6b and the head portion 6d, and as shown in FIG. 3, the neck portion 6c has a smaller diameter than the shoulder portion 6b and the head portion 6d. The neck portion 6c here stands from the surface 6f of the shoulder portion 6b and has a cylindrical shape. Rounded corners (radii) are formed in the corner portions formed by the shoulder portion 6b and the neck portion 6c and the corner portions formed by the head portion 6d and the neck portion 6c.

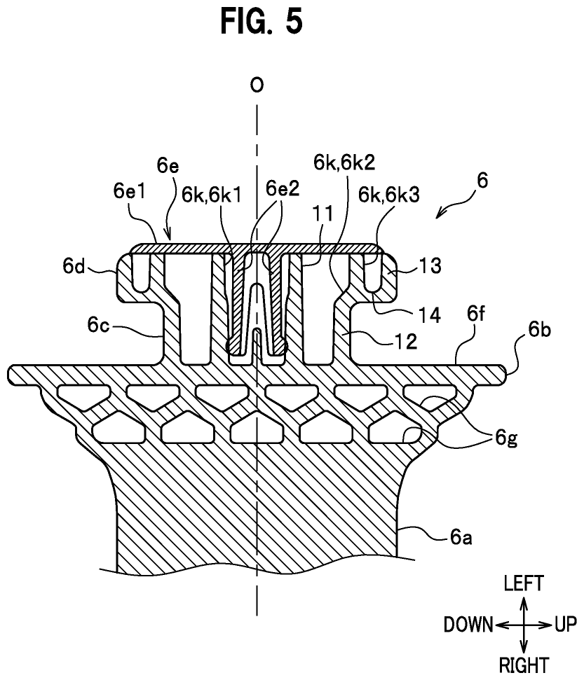

As shown in FIG. 2, multiple communication portions (first communication portions) 6m are formed in the neck portion 6c along the circumferential direction. Each communication portion 6m is a hole connecting the outside of the neck portion 6c and the cutout portion 6k (see FIG. 5). The communication portion 6m serves as an air release path for discharging air within the gap 6j when the parison S enters the gap 6j (described later) during molding. As long as the communication portion 6m can discharge air, its shape, number, and the like are not specifically limited.

The head portion 6d shown in FIG. 2 has the shape of a thick circular plate, thicker than the shoulder portion 6b. Note that the relationship in thickness between the shoulder portion 6b and the head portion 6d here is merely an example, and the shoulder portion 6b may be formed thicker than the head portion 6d. As shown in FIG. 3, the outer diameter rd of the head portion 6d is larger than the outer diameter rc of the neck portion 6c, and smaller than the outer diameter rb of the shoulder portion 6b. With this shape, a gap 6j is formed between the shoulder portion 6b and the head portion 6d, with the neck portion 6c as the bottom portion. The gap 6j is a place where the parison S enters during molding.

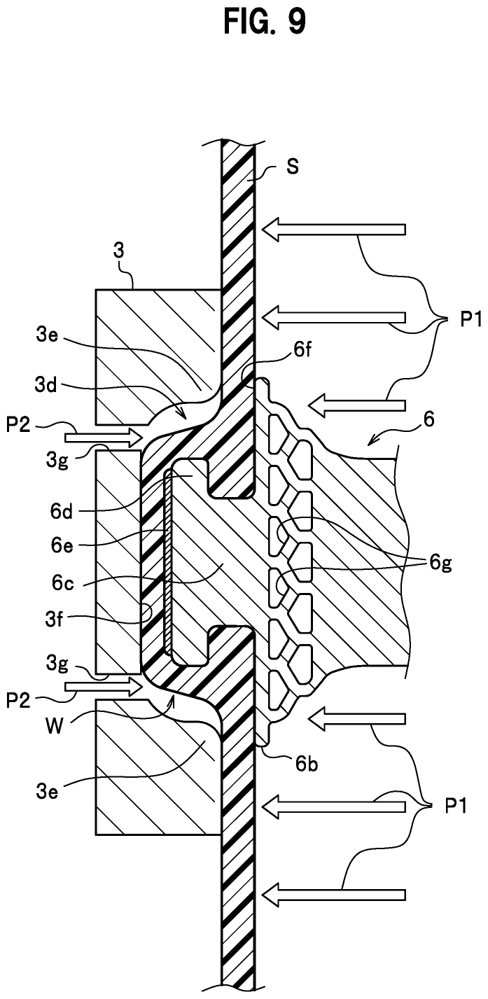

The shape and size of the head portion 6d are not particularly limited as long as the parison S can enter the periphery of the head portion 6d and the neck portion 6c, fixing the internal component 6 inside the tank body Ta (see FIG. 1). The portion corresponding to the parison wrapped around the neck portion 6c is called the “parison equivalent portion W” (see FIG. 9).

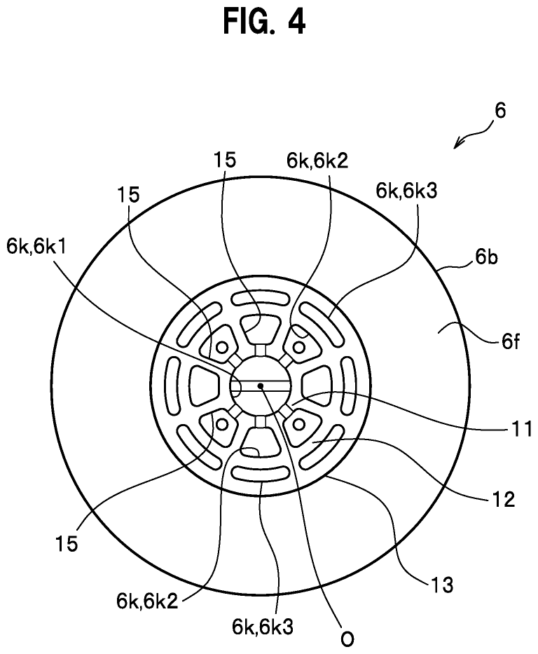

As shown in FIGS. 4 and 5, multiple cutout portions 6k are formed inside the neck portion 6c and the head portion 6d. The neck portion 6c and the head portion 6d include a first side wall 11, a second side wall 12, a third side wall 13, a bottom portion 14, and multiple ribs 15. The first side wall 11 has a cylindrical shape and stands vertically from the center of the shoulder portion 6b.

The second side wall 12 is substantially has a cylindrical shape and stands vertically from the shoulder portion 6b on the outside of the first side wall 11. The first side wall 11 and the second side wall 12 are of the same height and are provided from the neck portion 6c to the head portion 6d.

The third side wall 13 has a cylindrical shape and stands vertically from the bottom portion 14 on the outside of the second side wall 12. The bottom portion 14 protrudes laterally in the circumferential direction from the outer surface of the second side wall 12. The height of the third side wall 13 is about half of the second side wall 12. The ribs 15 extend radially with respect to the central axis O, continuing from the first side wall 11 to the third side wall 13. By providing the ribs 15, it is possible to prevent the inclination of the first side wall 11, the second side wall 12, and the third side wall 13 and to enhance the strength thereof.

Multiple cutout portions 6k are formed inside the neck portion 6c and head portion 6d of the aforementioned structures. When molding the internal component 6, there is a possibility that the resin at the end surface of the head portion 6d may shrink, causing the end surface to become concave. However, by providing a cutout portion 6k opening on that end surface, the resin during molding is easier to control, and molding accuracy can be improved. The cutout portion 6k includes a first cutout portion 6kl, multiple second cutout portions 6k2, and multiple third cutout portions 6k3. The first cutout portion 6kl is provided in the center portion and is a space enclosed by the shoulder portion 6b and the first side wall 11.

The second cutout portion 6k2 is a space enclosed by the shoulder portion 6b, the first side wall 11, the second side wall 12, and adjacent ribs 15, 15. The multiple second cutout portions 6k2 (eight in the present embodiment) are provided on the outside of the first cutout portion 6kl in the circumferential direction.

The third cutout portion 6k3 is a space enclosed by the bottom portion 14, the second side wall 12, the third side wall 13, and adjacent ribs 15, 15. The multiple third cutout portions 6k3 (eight in the present embodiment) are provided on the outside of the second cutout portions 6k2 in the circumferential direction. Although the second cutout portions 6k2 and the third cutout portions 6k3 are formed in eight pieces each in the present embodiment, the number can be set as appropriate.

As shown in FIG. 5, the bottom portion 14 is formed continuously with the third cutout portion 6k3 that opens upwards. The bottom portion 14 is a portion serving as a “fuse-shaped portion” for being broken near the boundary between the neck portion 6c and the head portion 6d. That is, the bottom portion 14 is formed such that it is broken when positive pressure is applied inside the fuel tank 1 and a predetermined stress acts on the bottom portion 14. By adjusting the thickness (length in the direction of the central axis O) of the bottom portion 14, it can be broken with the desired stress. The thickness (fuse-shaped portion) of the bottom portion 14 may vary in the circumferential direction, but it is preferable that the thickness thereof is constant as in the present embodiment. This can prevent stress from concentrating on the bottom portion 14 under normal conditions.

The cap member 6e shown in FIG. 5 is a member that is placed on the end surface of the head portion 6d to seal the opening of the cutout portion 6k. By sealing the opening of the cutout portion 6k, the cap member 6e can prevent the parison S from entering the cutout portion 6k during molding. The material of the cap member 6e is not particularly limited, but in the present embodiment, for example, it is made of the same material as the internal component 6.

As shown in FIG. 5, the cap member 6e includes a lid portion 6el and a leg portion 6e2. When the lid portion 6e1 is placed to seal the opening of the first cutout portion 6k1, the leg portion 6e2 is inserted into and engages with the first cutout portion 6kl. By engaging the leg portion 6e2 inside the first cutout portion 6kl, the lid portion 6e1 can be prevented from rotating and fixed.

The lid portion 6el has a flat surface and seals the opening of all the cutout portions 6k, playing a role in preventing the flow of parison S and the like into the cutout portions 6k. The shape of the lid portion 6el can be any shape that can seal the opening of the cutout portion 6k, and may be appropriately set according to the shape of the head portion 6d. Also, if there is another mechanism that can fix the lid portion 6e1, the leg portion 6e2 may be omitted.

### <<Method for Manufacturing Fuel Tank According to Embodiment>>

The fuel tank manufacturing device 1 shown in FIG. 7 is a device that blow-molds a cylindrical parison S to produce a fuel tank T having an internal component 6 (see FIG. 1). Additionally, the fuel tank T can also be manufactured by molding a sheet-shaped parison (not shown).

As shown in FIG. 7, the fuel tank manufacturing device 1 mainly includes a die 2, a pair of first mold 3 and second mold 4, and an elevator 5 that moves up and down between the first mold 3 and the second mold 4.

The die 2 is located above the first mold 3 and second mold 4 and is a supply means for supplying the parison S to the first mold 3 and second mold 4. The parison S has a multilayered structure composed of HDPE (high-density polyethylene), EVOH (ethylene-vinyl alcohol copolymer), adhesive layers, and the like, and is a precursor of the tank main body Ta that constitutes the fuel tank T (see FIG. 1).

The first mold 3 and second mold 4 shown in FIG. 7 are molding means for compression-molding the fuel tank T (see FIG. 1). The first mold 3 and second mold 4 are arranged facing each other, and concave molding portions 3a, 4a are formed on their opposing surfaces. The first mold 3 and second mold 4 can open and close by moving in the left-right direction, and the parison S is supplied when the first mold 3 and the second mold 4 are in an open state (state as shown in FIG. 7). Also, the first mold 3 and second mold 4 include not-shown blow pins to send in air to the first mold 3 and second mold 4, and the air pressure (blow pressure) inside the first mold 3 and second mold 4 is properly adjusted by a not-shown first positive pressure applying means. This first positive pressure applying means allows for transfer of the parison S to the molding portions 3a, 4a.

The first mold 3 is constructed to separate, and includes a main body portion 3b and a separable portion 3c that can be detached from the main body portion 3b. Similarly, the second mold 4 is constructed to separate, and includes a main body portion 4b and a separable portion 4c that can be detached from the main body portion 4b. The separable portions 3c, 4c are provided with recesses 3d, 4d formed therein, which correspond to the shapes of both ends of the internal component 6, and these recesses 3d, 4d accommodate a part of the internal component 6. The recesses 3d, 4d here have a cylindrical shape. Additionally, in the bottom portion 3f, 4f of the recesses 3d, 4d, multiple air holes 3g, 4g are formed to send in air to the recesses 3d, 4d, respectively, and the air pressure (blow pressure) inside the recesses 3d, 4d is properly adjusted by a not-shown second positive pressure applying means.

The elevator 5 is a moving means for moving the internal component 6 to its installation position. The installation position here is inside the cylindrical parison S, and is between the separable portions 3c, 4c.

Next, the operation of the fuel tank manufacturing device 1 will be described. Before explaining the entire process of manufacturing the fuel tank T (see FIG. 1) by the fuel tank manufacturing device 1, the transfer status around the end portions of the internal component 6 will be described.

### <Transfer Status Around End Portions of Internal Component>

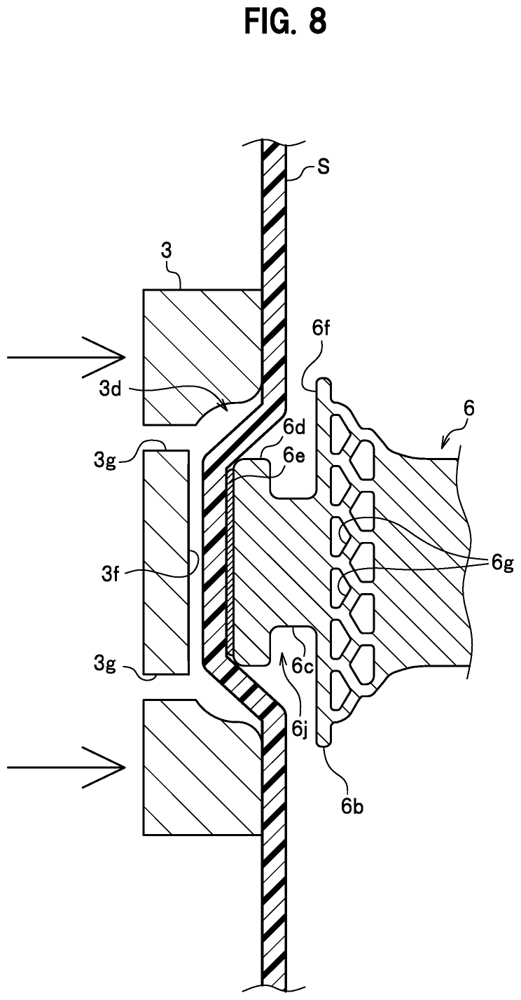

In reference to FIGS. 8 and 9 (and FIGS. 1 to 7 as appropriate), the transfer status of the parison S around the end portions of the internal component 6 during molding will be described. Note that here, the first mold 3 will be described, but the second mold 4 is similar.

In the fuel tank manufacturing process, as shown in FIG. 8, by moving the first mold 3 in the arrow direction and clamping, the neck portion 6c and head portion 6d of the internal component 6 are pushed into the recess 3d together with the parison S.

As shown in FIG. 9, when the shoulder portion 6b contacts the parison S to cover the opening of the recess 3d, and the neck portion 6c and head portion 6d are completely pushed into (housed in) the recess 3d, a positive pressure P1 (first positive pressure) is generated inside the parison S by sending air into the first mold 3, transferring the parison S to the first mold 3. In addition, by sending air into the recess 3d through the air holes 3g formed in the recess 3d, a positive pressure P2 (second positive pressure) is generated inside the recess 3d to allow the parison S to enter the gap 6j between the shoulder portion 6b and the head portion 6d for transfer. The air in the gap 6j is, as described above, discharged into the interior of the tank main body Ta by appropriately passing through the communication portions (the first communication portions) 6m, the cutout portions 6k, the communication portions penetrating the shoulder portion 6b (not shown), and the hollowing holes 6g.

Next, the overall process of the fuel tank manufacturing device 1 will be described.

### <Parison Injection Process>

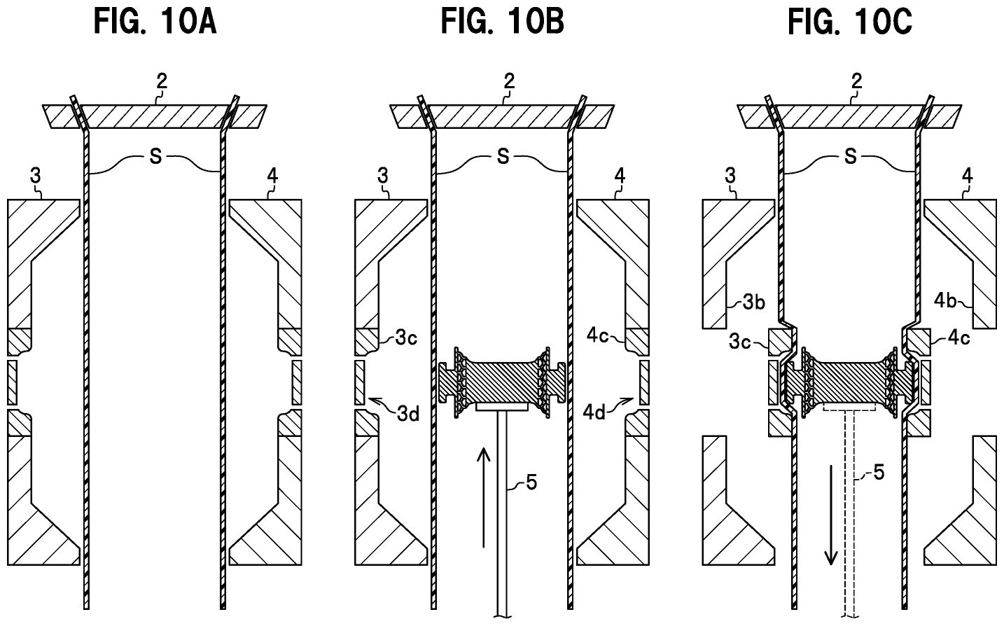

As shown in FIG. 10A, the die 2 injects a cylindrical parison S between the first mold 3 and the second mold 4 in an open state.

### <Internal Component Insertion Process>

Next, as shown in FIG. 10B, the elevator 5 rises with the internal component 6 held, and moves the internal component 6 to the attachment position. Here, the attachment position is inside the parison S and between the separable portions 3c, 4c.

### <Internal Component Temporary Setting Process>

Next, as shown in FIG. 10C, the separable portions 3c, 4c of the first mold 3 and second mold 4 move in directions facing each other to hold the internal component 6 by sandwiching it from both ends. Then, the elevator 5 descends with the internal component 6 released and retreats to the initial position. The initial position of the elevator 5 may be any position that does not interfere when the main body portions 3b, 4b of the first mold 3 and second mold 4 are closed.

### <Mold Closing Process>

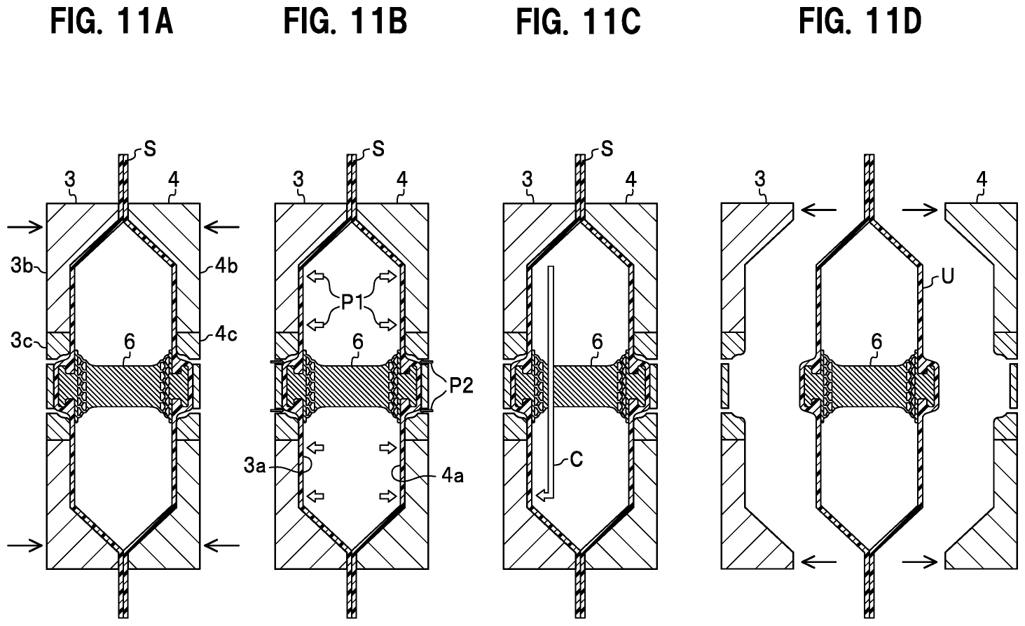

Next, as shown in FIG. 11A, the main body portions 3b, 4b of the first mold 3 and second mold 4 move in directions facing each other, and the first mold 3 and second mold 4 are clamped.

### <Blow Molding Process>

Next, as shown in FIG. 11B, the not-shown first positive pressure applying means applies a positive pressure P1 (first positive pressure) to the inside of the parison S in the first mold 3 and second mold 4. As a result, the parison S is pressed against and transferred to the molding portions 3a, 4a of the first mold 3 and second mold 4. Also, the not-shown second positive pressure applying means applies a positive pressure P2 (second positive pressure) to the outside of the parison S in the recesses 3d, 4d (see FIG. 7) of the first mold 3 and second mold 4. As a result, the parison S is shaped along the neck portion 6c of the internal component 6 (see FIG. 9). Note that there is no particular limitation on the method and order of applying the positive pressures P1 and P2. It is preferable that the positive pressure P2 is set higher than the positive pressure P1.

### <Parison Cooling Process>

Next, as shown in FIG. 11C, cooling air C is circulated inside the first mold 3 and second mold 4 using not-shown cooling means. As a result, the parison S is cooled and cured.

### <Mold Opening Process>

Next, as shown in FIG. 11D, the first mold 3 and second mold 4 are opened and the molded product U is taken out. Then, by cutting off unnecessary burrs formed at both ends, the fuel tank T (see FIG. 1) is completed.

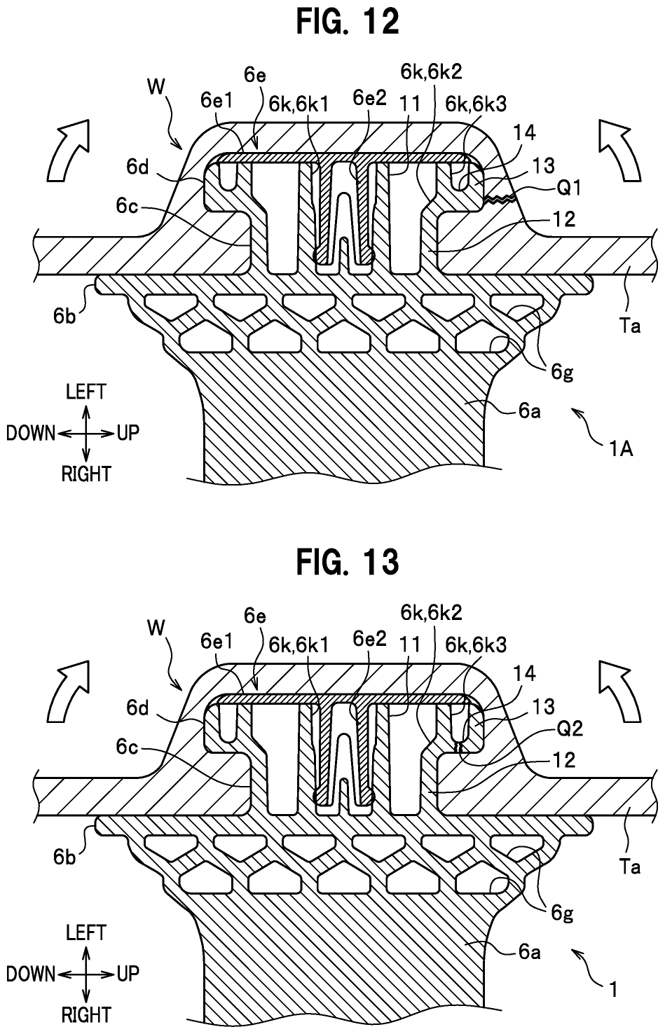

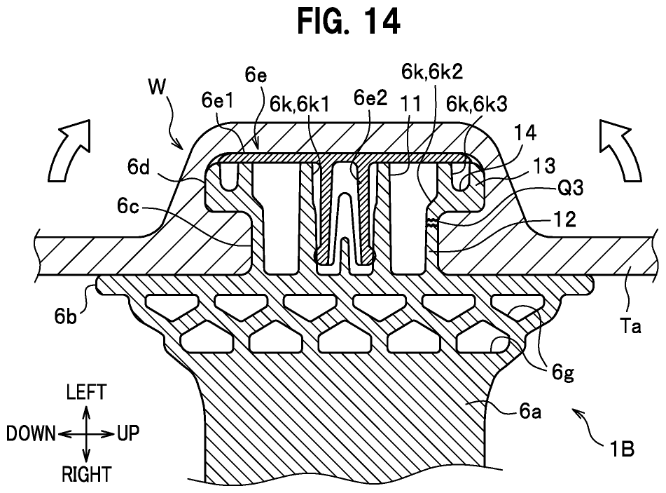

Here, FIG. 12 is a cross-sectional view showing the operation of a conventional fuel tank. In the case where no “fuse-shaped portion” is provided as in the conventional fuel tank, when a predetermined positive pressure acts inside the fuel tank 1A, a force will act such that the wall portion of the tank main body Ta extending around the head portion 6d rolls up towards the head portion 6d (see the bold arrows in FIG. 12). As a result, for example, there is a possibility that the area, near the head portion 6d, of the wall portion of the tank main body Ta may be broken at the breakage portion Q1.

In contrast, as shown in FIG. 13, in the present embodiment, by having a bottom portion 14 (fuse-shaped portion), it is possible to break the internal component 6 at the breakage portion Q2 of the head portion 6d. As a result, the broken head portion 6d remains on the wall portion of the tank main body Ta, and the other portions can be separated from the wall portion of the tank main body Ta, thereby preventing damage to the wall portion of the tank main body Ta.

Furthermore, the head portion 6d has multiple cutout portions 6k opening to the end surface of the head portion 6d, and the bottom portion 14 (fuse-shaped portion) is formed on radially outer side of the head portion 6d and continuously with the third cutout portions 6k3. This makes it possible to easily form the fuse-shaped portion by adjusting the thickness of the bottom portion 14 using the third cutout portions 6k3.

Also, according to the present embodiment, by providing a cap member 6e on the head portion 6d of the internal component 6, it is possible to prevent the parison S from entering the cutout portions 6k during molding. Therefore, it is possible to reduce the variation in thickness of the parison S and prevent the barrier layer from getting broken or damaged.

Furthermore, in the shoulder portion 6b, since a communication portion (not shown) penetrating in the height direction is formed, it is possible to flow the air in the gap 6j from the communication portion 6m into the cutout portions 6k, and discharge the air in the cutout portions 6k from the communication portion (not shown) into the tank main body Ta. As a result, it is possible to reliably perform air removal, and it is possible to securely shape the parison around the neck portion 6c.

### [Modification]

Next, a fuel tank 1B according to a modification of the present invention will be explained. In the modification, the position of the fuse-shaped portion is different from the above-described embodiment, so that the explanation will focus on the differences.

In the modification, a “fuse-shaped portion” is set on the second side wall 12, which continues with the second cutout portions 6k2. That is, by reducing (thinning) the wall thickness of the second side wall 12, when a predetermined positive pressure is applied to the fuel tank 1B, it is designed to be broken at the breakage portion Q3 of the second side wall 12. In other words, the neck portion 6c is formed to be broken. In this case as well, the wall thickness of the second side wall 12 remains consistent in the circumferential direction. Thus, the “fuse-shaped portion” may be provided on the neck portion 6c (second side wall 12). In this way, an effect substantially equivalent to the aforementioned embodiment can be obtained.

The embodiments and modifications of the present invention have been described above, but design changes can be made as appropriate without departing from the spirit of the present invention. For instance, the “fuse-shaped portion” can be provided in other portions as long as it can be broken near the boundary between the head portion 6d and the neck portion 6c, either within the head portion 6d or the neck portion 6c. The “fuse-shaped portion” can be provided on both the bottom portion 14 and the second side wall 12, or on the third side wall 13. Also, in the present embodiment, the parison is wrapped around the neck portion by positive pressure from the outside of the parison (blow molding) to fix the internal components, but other molding methods may be used. Additionally, the cap member 6e can be omitted.

### REFERENCE SIGNS LIST

6 internal component
6a torso portion
6b shoulder portion
6c neck portion
6d head portion
6e cap member
6k cutout portion
11 first side wall
12 second side wall
13 third side wall
14 bottom portion (fuse-shaped portion)
15 rib
S parison
T fuel tank
Ta tank main body

1. A fuel tank comprising:
an internal component including a head portion, a neck portion, and a shoulder portion, the internal component being fixed on the tank main body by shaping a parison to the head portion, the neck portion and the shoulder portion during molding of the tank main body,
wherein at least one of the head portion and the neck portion includes a fuse-shaped portion to be broken near a boundary between the head portion and the neck portion,
wherein the head portion is formed with multiple cutout portions opening to an end surface of the head portion, and
wherein fuse-shaped portions are formed on radially outer side of the head portion and continuously with the multiple cutout portions.

2. A fuel tank comprising:
an internal component including a head portion, a neck portion, and a shoulder portion, the internal component being fixed on the tank main body by shaping a parison to the head portion, the neck portion and the shoulder portion during molding of the tank main body,
wherein at least one of the head portion and the neck portion includes a fuse-shaped portion to be broken near a boundary between the head portion and the neck portion,
wherein multiple cutout portions are formed to communicate from the head portion to the neck portion and open to an end surface of the head portion, and
wherein fuse-shaped portions are formed on radially outer side of the neck portion and continuously with the multiple cutout portions.

3. A fuel tank comprising:
an internal component including a head portion, a neck portion, and a shoulder portion, the internal component being fixed on the tank main body by shaping a parison to the head portion, the neck portion and the shoulder portion during molding of the tank main body,
wherein at least one of the head portion and the neck portion includes a fuse-shaped portion to be broken near a boundary between the head portion and the neck portion,
wherein the head portion includes a bottom portion to be the fuse-shaped portion, and a side wall standing from the bottom portion, and
wherein the bottom portion has a constant thickness in a circumference direction.

4. A fuel tank comprising:
an internal component including a head portion, a neck portion, and a shoulder portion, the internal component being fixed on the tank main body by shaping a parison to the head portion, the neck portion and the shoulder portion during molding of the tank main body,
wherein at least one of the head portion and the neck portion includes a fuse-shaped portion to be broken near a boundary between the head portion and the neck portion,
wherein the neck portion includes a side wall to be the fuse-shaped portion, and
wherein the side wall has a constant thickness in a circumference direction.
